(19) United States
(12) Patent Application Publication
(10) Pub. No.: US 2009/0120004 A1
(43) Pub. Date: May 14, 2009

(54) Mounting assembly for closure devices

(76) Inventor: William M. Cobb, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/983,977

(22) Filed: Nov. 13, 2007

(51) Int. Cl. E05D 15/00

(52) U.S. Cl. 49/381; 49/452; 49/507

(57) ABSTRACT

The invention is a mounting assembly for closure devices, such as doors, retractable screens, sliding doors, or the like. The mounting assembly comprises a mounting bracket and a main body, wherein the mounting bracket is attached directly to an enclosure component and the main body are fitted to the mounting bracket at a non-parallel orientation. In this manner, the mounting assembly compensates for misaligned enclosure components, thus promoting easy and efficient operation of the closure device.

### BACKGROUND OF THE INVENTION

This invention generally relates to the field of closure devices for any area to be enclosed, and more particularly to retractable shower screen closure devices having an assembly for mounting the device to out-of-plum walls and in custom shower enclosure areas.

Generally, closure devices include doors, retractable screens, sliding panels, and the like. These devices may be used to enclose porches, rooms, patios, swimming pool areas, shower areas, closets, booths, or any other similar area. Typically, the closure device is attached to a component of the area to be enclosed. In many circumstances, such enclosure components may be misaligned. As a result, the closure device may not fit correctly, or it may be difficult to operate due to the misalignment. In addition, many enclosure areas in modern construction incorporate custom shaped features. Thus, when the enclosure component includes custom designed corners or contoured edges, it may be difficult to use conventional closure devices in an aesthetically pleasing, well-fit manner.

It is an object of the present invention to provide a mounting assembly that compensates for out-of-plumb or misaligned frames when attaching an closure device to an enclosure component. It is a further object of the present invention to provide a mounting assembly that can be easily shaped to fit a custom designed frame of an enclosure area.

### SUMMARY OF THE INVENTION

The mounting assembly comprises a mounting bracket and a main body. The mounting bracket further comprises a base plate and at least one bracket flange, which is attached to the base plate. The main body further comprises a main wall and at least two side walls, which are attached to the main wall, thereby forming a U-shaped channel. The side walls are spaced such that the bracket flange(s) may be snugly disposed adjacent to the side walls. The mounting bracket is attached directly to the enclosure component, and the main body is fitted to the mounting bracket at either a parallel or non-parallel orientation, thus correcting for misaligned enclosure components. The closure device is attached to the main wall of the main body on the side opposite the side walls.

The width of the bracket flange(s) and side walls will vary and are fabricated at a width sufficient to fit any custom features of the enclosure component or edges, as for example rounded corners or contoured edges of the opening. In addition, the bracket flanges and side walls are fabricated at a width sufficient to account for severely misaligned enclosure components.

An optional screen track assembly for a retractable shower screen comprises the mounting assembly, a top track, a bottom track, and a retaining member. The top track and bottom track are attached to the main body of the mounting assembly or to a component of the enclosure's opening. The retaining member is attached to the top track and bottom track, or it is attached to another component of the enclosure's opening. The retractable screen travels inside and along the tracks when the screen is drawn from or released to the screen coil, and the screen is retained in its extended position by attaching one end of the screen to the retaining member.

### BRIEF DESCRIPTION OF THE DRAWINGS

FIG. 1 is an isometric view of the mounting assembly showing the enclosure component, mounting bracket, main body, and closure device.

FIG. 1a is an isometric view of the mounting assembly in FIG. 1, wherein a connection bracket connects the main body to a structural component of the enclosed area.

FIG. 2 is a cross section of the mounting assembly showing the enclosure component, mounting bracket and main body.

FIG. 3 is an elevation of the connection detail at the bottom of the mounting assembly.

FIG. 4 is a cross section of the mounting assembly having two bracket flanges on the mounting bracket, where the bracket flanges are disposed inside the side walls of the main body.

FIG. 5 is a cross section of the mounting assembly having two bracket flanges on the mounting bracket, where the bracket flanges are disposed outside the side walls of the main body.

FIG. 6 is an exploded view of the mounting assembly used in connection with a retractable shower screen and track assembly.

FIG. 7 is an elevation of the mounting assembly used in connection with a retractable shower screen and track assembly.

FIG. 8 is a cross section of the mounting assembly wherein the main body is integrally connected to the housing for a retractable shower screen.

### DETAILED DESCRIPTION OF THE INVENTION

With reference to the drawings, the invention will now be described with regard for the best mode and the preferred embodiment. In general, the invention is a mounting assembly for closure devices, such as doors, retractable screens, sliding panels, or the like. The mounting assembly comprises a means for correcting misaligned openings of the area to be enclosed and a means for adaptably attaching the mounting assembly to custom designed features of the enclosed area. The most basic embodiment of the invention is used to enclose the opening of any area, such as porches, rooms, patios, swimming pool areas, shower areas, closets, sheds, booths, or any other similar area.

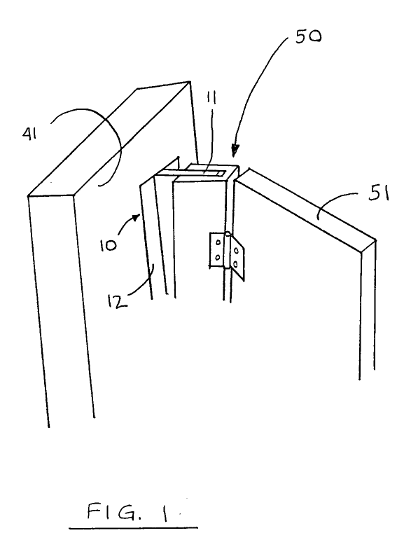

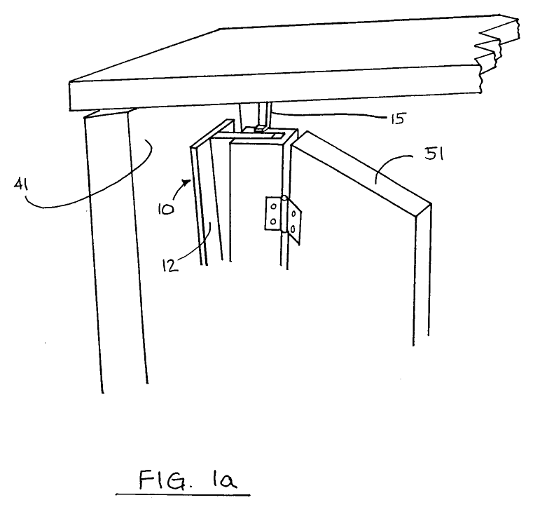

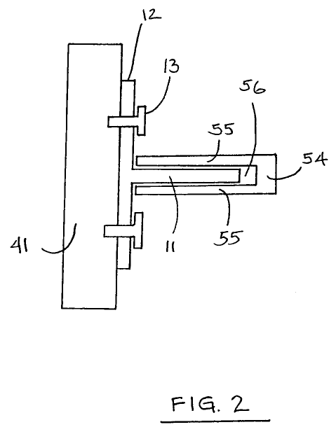

In one embodiment, shown in FIGS. 1 and 2, the invention generally comprises a mounting bracket 10 and an elongated main body 50. The main body 50 comprises a main wall 54 and at least two side walls 55 that define a generally U-shaped channel 56. The side walls 55 are attached to one side of the main wall 54, and the side walls 55 are disposed either continuously or discontinuously along the length of the main wall 54. The closure device 51 is attached by any suitable means to the main body 50 on the side opposite that of the side walls 55. The main body 50 is made of any metal, polymer, fiberglass, carbon-fiber material, ceramic, or any sufficiently rigid material.

The mounting bracket 10 comprises an elongated base plate 12 that is generally of a length similar to that of the main body 50. At least one bracket flange 11 is connected to the base plate 12 by any suitable means, and it is preferable, but not necessary, that the bracket flange 11 run continuously along the length of the base plate 12. The side walls 55 are spaced such that the bracket flange 11 are snugly disposed inside the U-shaped channel 56. The mounting bracket 10 is made of any metal, polymer, fiberglass, carbon-fiber material, ceramic, or any sufficiently rigid material. Generally, the area to be enclosed will have an opening of some kind. The mounting bracket 10 is attached to an enclosure component 41 of the enclosure's opening. The enclosure component 41 is a frame, vertical member, horizontal member, wall, post, or any other element capable of securing the mounting bracket 10. The mounting bracket 10 is attached to the enclosure component 41 by a suitable chemical bond such as glue, epoxy, caulking, or the like. Alternately, the mounting bracket 10 is attached to the enclosure component 41 by mechanical anchors 13, such as bolts, screws, rivets, dowels, or other types of anchors.

In some instances, the geometry of the enclosure area is such that the enclosure component 41 is oriented at an angle that encumbers operation of the closure device 51. In these situations, the enclosure component 41 is said to be misaligned. For example, the closure device 51 may comprise a door that swings on hinges where the hinges are oriented in a substantially vertical manner and the door swings in a substantially horizontal plane. If the hinges attach to an enclosure component 41 that is not aligned at a perfectly vertical orientation, then gravitational forces may cause the door naturally to swing open or closed, depending on the orientation of the door and enclosure component 41.

In the case of misaligned enclosure components 41, if the main body 50 is oriented parallel to the enclosure component 41, then operation of the closure device 51 is encumbered. To correct the misalignment problem, the mounting bracket 10 is attached directly to the enclosure component 41 in a parallel manner, and the main body 50 is fitted to the mounting bracket 10 at a non-parallel orientation. The bracket flange 11 and the side walls 55 are fabricated to a width that is sufficient to account for even severe misalignment. In these instances, the bracket flange 11 and the side walls 55 are positioned such that there is no visible gap between them, thus providing an aesthetically pleasing interface between the main body 50 and the enclosure component 41.

After the main body 50 and the mounting bracket 10 are oriented in the non-parallel manner described above, they are connected together by a connection means in a fixed relation, such as by placing between the bracket flange 11 and the U-shaped channel 56 a chemical bond, such as an adhesive, epoxy, glue, or caulking. Alternately, the bracket flange 11 and the side walls 55 are connected by mechanical fasteners such as screws, bolts, rivets, clamps, welds, or the like. As a further connection alternate, there may be no connection means between the bracket flange 11 and the side walls 55. Instead, the main body 50 is connected to another structural feature, such as the structural components of the enclosure. In FIG. 1a for example, the main body 50 can be attached directly to the enclosure component 41 by a separate attachment bracket 15.

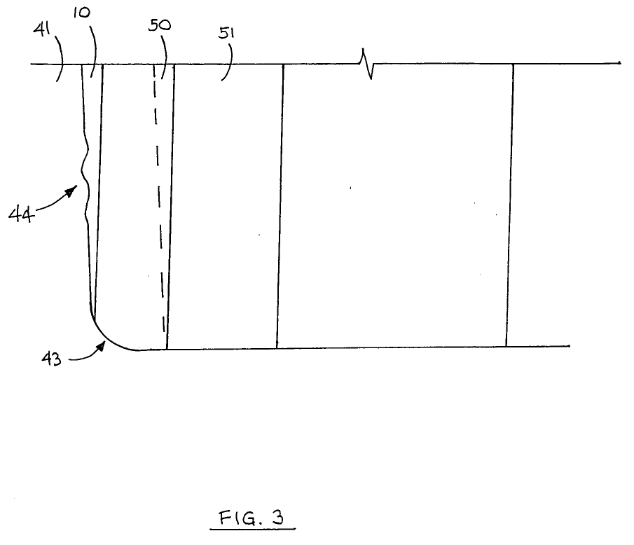

Referring to FIG. 3, the mounting bracket 10 and side walls 55 are altered to fit the shape of any custom corner 43 or contoured edges 44 of the enclosure component 41. This alteration is made by cutting, bending, molding, or the like. When a custom corner 43 is rounded at a large radius, the width of the bracket flange 11 and side walls 55 are increased so that they can be shaped to fit the contour of the custom corner 43. As a result, the mounting bracket 10 and main body 50 are attached to a custom enclosure in an aesthetically pleasing manner with no gaps or irregularities at the interface between the mounting bracket 10 and the enclosure component 41. This interface has the added capability of providing a water-tight seal for enclosures such as showers.

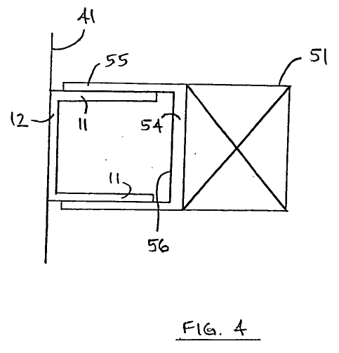

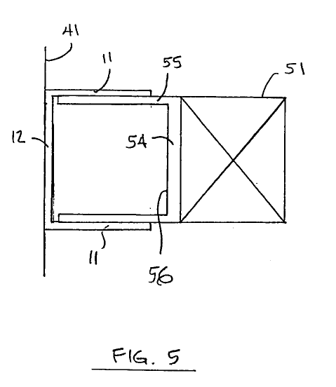

Preferably, the mounting bracket 10 has at least two bracket flanges 11, as shown in FIGS. 4 and 5. In this embodiment, it is preferred that the side walls 55 are disposed on the main body 50 in a manner such that the bracket flanges 11 are snugly disposed inside the U-shaped channel 56. Alternately, as shown in FIG. 5, the side walls 55 are disposed on the main body 50 in a manner such that the side walls 55 fit snugly adjacent to the inside the bracket flanges 11.

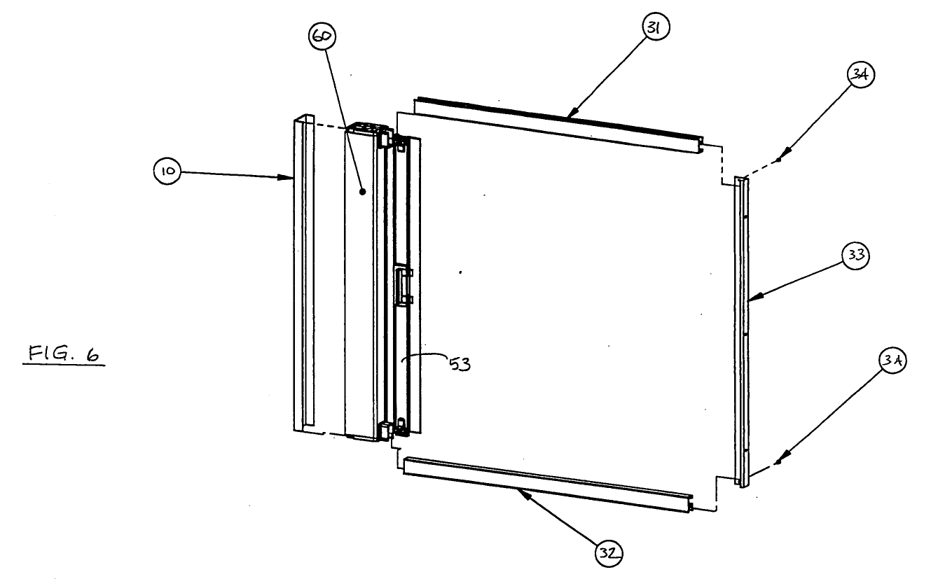

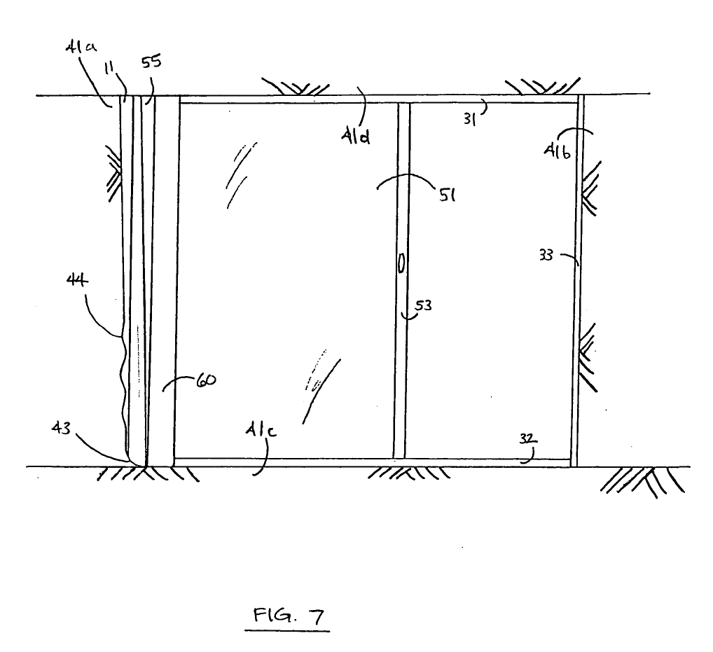

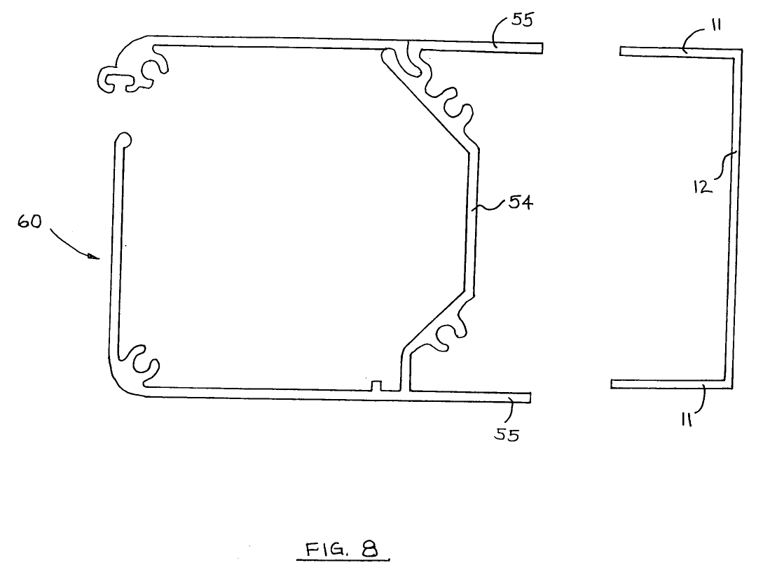

FIGS. 6 and 7 show an embodiment of the invention wherein the area to be enclosed is a shower area, and the closure device 51 is a retractable shower screen or a slidable panel. The mounting assembly generally comprises the mounting bracket 10 and main body 50 as previously described, an optional shower screen housing 60, an upper track 31, a lower track 32, a holding member 33 such as a hook, latch, clasp, or the like, and any necessary connection means 34 to retain the retractable screen in an extended position. The housing 60 may or may not be integrally attached to the main body 50 of the mounting bracket assembly. An integral connection is shown in FIGS. 6 and 8. A non-integral connection is shown in FIG. 7. The upper track 31 and lower track 32 are generally elongated channel-shaped members. The tracks can be curved such that the retractable screen maintains a curved shape in its extended position.

On one embodiment, the bracket flanges 11 fit to the side walls 55 as previously described, and the main body 50 and housing 60, if any, are attached adjacent to a first side enclosure component 41a. The holding member 33 is attached to a second side enclosure component 41b by any chemical bond or mechanical attachment. The bottom track 32 is attached to a bottom enclosure component 41c, which is oriented generally perpendicular to the first enclosure component 41a. Alternately, the bottom track 32 is attached to the main body 50 or housing 60 at one end and the holding member 33 at the other end. Such connections are made by any suitable connection means 34, such as mechanical fasteners or chemical bonds.

The top track 31 is attached to a top enclosure component 41d, which is located near the top of the enclosure and oriented generally perpendicular to the first enclosure component 41a and generally parallel to the bottom enclosure component 41c. Alternately, the top track 31 is attached to the main body 50 or housing 60 at one end and the holding member 33 at the other end by any suitable connection means 34, such as mechanical fasteners or chemical bonds. When the closure device 51 is drawn, the handle member 53 and closure device 51 travel inside and along the tracks and attach to the opposite side of the opening via the holding member 33.

In another embodiment, the connection means 34 are configured to prevent rotation in the joint, thus creating a substantially rigid rectangular frame that comprises the main body 50, the top track 31, the bottom track 32, and the holding member 33. This configuration is adjusted to form a perfectly perpendicular rectangle. As a result, the closure device 51 moves efficiently and smoothly through the track assembly regardless of any misalignment in the enclosure components 41, custom corners 43, or contoured edges 44. Additionally, when the connection means 34 provide sufficient resistance to rotation, a bonding means between the bracket flanges 11 and the side walls 55 is optional, but not necessary.

The embodiments disclosed above are merely representative of the invention and not meant for limitation of the invention. For example, the embodiments discussed above describe the mounting assembly as having a substantially vertical orientation. One having ordinary skill in the art would understand that the mounting assembly described herein may be installed with a substantially horizontal orientation, thereby permitting the closure device 51 to swing or slide in a substantially vertical direction. It is understood that equivalents and substitutions for certain elements and components set forth above may be obvious to those having ordinary skill in the art, and therefore the true scope and definition of the invention is to be as set forth in the following claims.

I claim:

1. A mounting assembly for a closure device comprising;
a main body having an elongated main wall and at least two side walls attached to one side of said main wall, said side walls and said main wall forming a U-shaped channel; and
a mounting bracket having an elongated base plate and at least one bracket flange attached to said base plate, wherein said at least one bracket flange is disposed adjacent to said side walls of the main body in a manner whereby said mounting bracket and said main body may be aligned in either a parallel or nonparallel orientation.

2. The assembly of claim 1, wherein said mounting bracket and said side walls are at least one half of one inch wide.

3. The assembly of claim 1, wherein said mounting bracket further comprises at least two bracket flanges and said side walls of said main body are fixed at a location on said main body such that said side walls are snugly disposed inside of said bracket flanges.

4. The assembly of claim 1, wherein said mounting bracket further comprises at least two bracket flanges and said side walls of said main body are fixed at a location on said main body such that said bracket flanges are snugly disposed inside said U-shaped channel.

5. The assembly of claim 4, wherein said assembly further comprises a housing, said housing being attached to said main wall on the side of the main wall opposite that of said side walls.

6. The assembly of claim 1, wherein a connection means is used to retain said main body in a fixed relation to said mounting bracket.

7. The assembly of claim 6, wherein said mounting bracket and said side walls are at least one half of one inch wide.

8. The assembly of claim 6, wherein said mounting bracket further comprises at least two bracket flanges and said side walls of said main body are fixed at a location on said main body such that said side walls are snugly disposed about said bracket flanges on the inside of said bracket flanges.

9. The assembly of claim 6, wherein said mounting bracket further comprises at least two bracket flanges and said side walls of said main body are fixed at a location on said main body such that said bracket flanges are snugly disposed inside said U-shaped channel.

10. The assembly of claim 9, wherein said assembly further comprises a housing, said housing being attached to said main wall on the side of the main wall opposite that of said side walls.

11. A mounting assembly for a retractable screen closure device, said assembly comprising:
a main body having an elongated main wall and at least two side walls attached to one side of said main wall, said side walls and said main wall forming a U-shaped channel; and
a mounting bracket having an elongated base plate and at least one bracket flange attached to said base plate, wherein said at least one bracket flange is disposed adjacent to said side walls of the main body in a manner whereby said mounting bracket and said main body may be aligned in either a parallel or nonparallel orientation; and
a screen track assembly having a slidable closure device, a top track attached to said main body, a bottom track attached to said main body, and a retaining member attached to said top track and said bottom track, wherein said slidable closure device travels inside and along said top track and said bottom track when said slidable closure device is drawn or released, and said slidable closure device is held in its extended position by an attachment to said retaining member.

12. The assembly of claim 11, wherein said mounting bracket and said side walls are at least one half of one inch wide.

13. The assembly of claim 11, wherein said bracket further comprises at least two bracket flanges and said side walls of said main body are fixed at a location on said main body such that said side walls are snugly disposed inside of said bracket flanges.

14. The assembly of claim 11, wherein said bracket further comprises at least two bracket flanges and said side walls of said main body are fixed at a location on said main body such that said bracket flanges are snugly disposed inside said U-shaped channel.

15. The assembly of claim 14, wherein said assembly further comprises a housing, said housing being attached to said main wall on the side of the main wall opposite that of said side walls.

16. The assembly of claim 1 1, wherein a connection means is used to retain said main body in a fixed relation to said mounting bracket.

17. The assembly of claim 16, wherein said mounting bracket and said side walls are at least one half of one inch wide.

18. The assembly of claim 16, wherein said bracket further comprises at least two bracket flanges and said side walls of said main body are fixed at a location on said main body such that said side walls are snugly disposed inside of said bracket flanges.

19. The assembly of claim 16, wherein said bracket further comprises at least two bracket flanges and said side walls of said main body are fixed at a location on said main body such that said bracket flanges are snugly disposed inside said U-shaped channel.

20. The assembly of claim 16, wherein said assembly further comprises a housing, said housing being attached to said main wall on the side of the main wall opposite that of said side walls.
